(19) United States
(12) Patent Application Publication
(10) Pub. No.: US 2025/0009597 A1
(43) Pub. Date: Jan. 9, 2025

(54) METHOD OF WIRELESSLY CONTROLLING VIBRATIONAL LARYNGEAL NERVE EXCITATION SYSTEM

(71) Applicant: Passy-Muir, Inc., Irvine, CA (US)

(72) Inventors: Alex Jolly, Newport Beach, CA (US); Cameron Jolly, Newport Beach, CA (US); Kristin King, Littleton, NC (US); Jose Comino, Irvine, CA (US); Daniel Carrillo, Irvine, CA (US); Wayne Fong, Irvine, CA (US); Kenneth Green, La Habra Heights, CA (US)

(21) Appl. No.: 18/894,514

(22) Filed: Sep. 24, 2024

Related U.S. Application Data
(63) Continuation of application No. 18/524,927, filed on Nov. 30, 2023.
Application No. 18/524,927 is a continuation of application No. 17/887,299, filed on Aug. 12, 2022, now Pat. No. 11,850,205.
Application No. 17/887,299 is a continuation of application No. 17/305,282, filed on Jul. 2, 2021, now Pat. No. 11,413,214.
Application No. 17/305,282 is a continuation of application No. 16/853,477, filed on Apr. 20, 2020, now abandoned.
(60) Provisional application No. 62/836,195, filed on Apr. 19, 2019.

(51) Int. Cl. A61H 23/02

(52) U.S. Cl. CPC A61H 23/02; A61H 2201/1611; A61H 2201/165; A61H 2201/501; A61H 2201/5071; A61H 2205/04

(57) ABSTRACT

A laryngeal nerve exciting system includes a collar holding a bridge, or a neckband, pressing soft tissue nerve exciters against a patient's neck providing a source of vibrations to stimulate the laryngeal nerve through the larynx. At least one exciter, and preferably two exciters, provide vibrations at preferably 70 Hz to 110 Hz and sufficiently strong to penetrate to the laryngeal nerve. The exciters may be held by the collar circling the neck, or by the neck band partially circling the neck. The therapy system includes a Personal Digital Assistant (PDA) and software which wirelessly connects, monitors, and triggers the device. The system may be used to treat dysphagia, chronic cough, and spasmodic dysphonia.

### CROSS-REFERENCE TO RELATED APPLICATIONS

The application is a continuation of U.S. patent application Ser. No. 18/524,927, filed Nov. 30, 2023, which is a continuation of U.S. patent application Ser. No. 17/887,299, filed Aug. 12, 2022, now U.S. Pat. No. 11,850,205, issued Dec. 26, 2023 which is a continuation of U.S. patent application Ser. No. 17/305,282, filed Jul. 2, 2021, now U.S. Pat. No. 11,413,214, issued Aug. 16, 2022 which is a continuation of U.S. patent application Ser. No. 16/853,477, filed Apr. 20, 2020, now abandoned, which claims the priority of U.S. Provisional Patent Application No. 62/836,195, filed Apr. 19, 2019, the disclosures of each of which is incorporated in its entirety herein by reference.

### BACKGROUND

The present invention relates to human tissue stimulation and in particular to noninvasive vibration on the neck overlying the larynx to excite the laryngeal nerve to augment or reestablish swallowing control during rehabilitation of patients with dysphagia, and to treat voice disorders affecting the function of the laryngeal system, such as spasmodic dysphonia, and to treat chronic cough.

Dysphagia is a major swallowing disorder that effects the central nervous system, and the peripheral nervous system, thereby weakening neuromuscular control and effectively reducing the ability to properly swallow. Dysphagia may occur at any time across the lifespan. This impairment has many potential causes, including but not limited to neurologic disorders, degenerative disease processes, and anatomical changes. Dysphagia is characterized by difficulty swallowing, impaired ability to protect the airway during swallowing (penetration and aspiration), and impaired ability to transport a bolus of food or liquid from the mouth to the stomach. These difficulties may contribute to a risk for respiratory complications (pneumonia), dehydration, malnutrition, and may restrict social eating. Because of these negative impacts, it also may significantly impact quality of life for an individual.

An occasional cough is normal in that it helps to clear irritants and secretions from the lungs; however, when a cough lasts longer than eight weeks in adults and begins to interfere with daily functions, such as sleep and bladder control, then it may be diagnosed as a chronic cough. In children, this diagnosis may occur after four weeks of coughing. Chronic cough occurs in the upper airway of the respiratory system, and the condition may be caused by co-morbidities, such as asthma, post-nasal drip, or reflux. However, the mechanism is unknown. The cough reflex may be impaired by a disease condition that weakens the cough which could lead to muscle weakness or paralysis, or it may be secondary to laryngeal nerve involvement.

Spasmodic dysphonia is a disorder that may occur with neurological disorders or disease processes that impact laryngeal function and muscles of the voice. This disorder of the laryngeal system causes the muscles involved in voicing to periodically spasm, triggering increased tension and a distortion of the voice. The spasms cause interruptions and breaks in the voice. Causes of spasmodic dysphonia are unknown but may relate to such processes as anxiety, infection, or direct injury to the larynx. It is more common in women and occurs most often between the ages of 30-50 years.

Any neurologic disease or process that impacts laryngeal function may negatively impact swallowing, voicing, and airway functions such as cough and throat clear, or any function that originates within or requires function of the laryngeal system. Various functions within the laryngeal system occur due to stimulation of the afferent pathways which transmit impulses to the brain and are then interpreted for communication with the efferent system for movement. Current treatment for an impairment or changes of laryngeal function that is caused by various neurological disorders or laryngeal injury are typically long-term behavioral therapy or invasive treatment with the injection of foreign materials or medications into the muscles, nerves, or tissues of the larynx. However, various disorders, such as dysphagia, chronic cough, and voicing disorders, may be improved by innervation of the afferent system within the larynx including the branches of the vagus nerve, such as the recurrent laryngeal, superior laryngeal, and pharyngeal branches, and vibration is known to relax muscles and to provide stimulation to tissues being innervated offering an alternative treatment.

U.S. Pat. No. 8,388,561 describes a vibrotactile stimulator having a band 101 worn around a patient's neck and including a vibrator 102 positionable over the larynx to provide stimulation generally centered on the patient's neck. The vibrator 102 is an electric motor spinning an offset weight. While the '561 patent provides a potential method for addressing dysphagia, there remains a need for improved dysphagia therapy devices.

### SUMMARY

The present invention addresses the above and other needs by providing a vibrating laryngeal nerve exciting device which includes a collar holding a bridge, or a neckband, pressing soft tissue nerve exciters against a patient's neck providing a source of vibrations to stimulate the branches of the vagus nerve, such as the recurrent laryngeal, superior laryngeal, and pharyngeal branches. At least one exciter, and preferably two exciters, provide vibrations preferably adjustable between 30 Hz and 200 Hz and more preferably between 70 and 110 Hz and sufficiently strong to penetrate to the laryngeal nerve, for example, a pressure of 2-4 kpa or a vibration amplitude of 0.15 mm to 0.25 mm. The exciters may be held by the collar circling the neck, or by the neck band partially circling the neck. The therapy system includes a Personal Digital Assistant (PDA) device and software which wirelessly connects, monitors, and triggers the device. The system may be used to treat dysphagia, chronic cough, and spasmodic dysphonia.

In accordance with one aspect of the invention, there is provided software (e.g., a smartphone application) which wirelessly connects and triggers the device, for example, through a Bluetooth® protocol. The software sets the frequency of the device, intensity, therapy time, vibration time, duration of rest period between vibration, and allows for patients to provide feedback about the therapy. A general state of health section allows the patient to diary how the patient is feeling before and after the therapy. The software allows clinicians to monitor the patient's progress. The clinician can see the device settings (frequency of the device, intensity, therapy time, vibration time, duration of rest period between vibration), number of uses, whether therapy was completed, and the patient's feedback diary.

### BRIEF DESCRIPTION OF THE DRAWINGS

The above and other aspects, features and advantages of the present invention will be more apparent from the following more particular description thereof, presented in conjunction with the following drawings.

FIG. 1A shows a front view of a laryngeal nerve exciter according to the present invention.

FIG. 1B shows a top view of the laryngeal nerve exciter according to the present invention.

FIG. 1C shows a rear view of the laryngeal nerve exciter according to the present invention.

FIG. 2 shows an end effector of the laryngeal nerve exciter according to the present invention.

FIG. 3 shows a top view of a second embodiment of a laryngeal nerve exciter according to the present invention.

FIG. 4 shows a neckband laryngeal nerve exciter according to the present invention on a patent.

FIG. 5 shows a top view of the neckband laryngeal nerve exciter according to the present invention.

FIG. 6 shows a perspective view of the neckband laryngeal nerve exciter according to the present invention.

FIG. 7 shows a nerve exciter of the neckband laryngeal nerve exciter according to the present invention.

FIG. 8 shows an adhesive pad of the neckband laryngeal nerve exciter according to the present invention.

FIG. 9 shows a laryngeal nerve exciting system according to the present invention.

Corresponding reference characters indicate corresponding components throughout the several views of the drawings.

### DETAILED DESCRIPTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

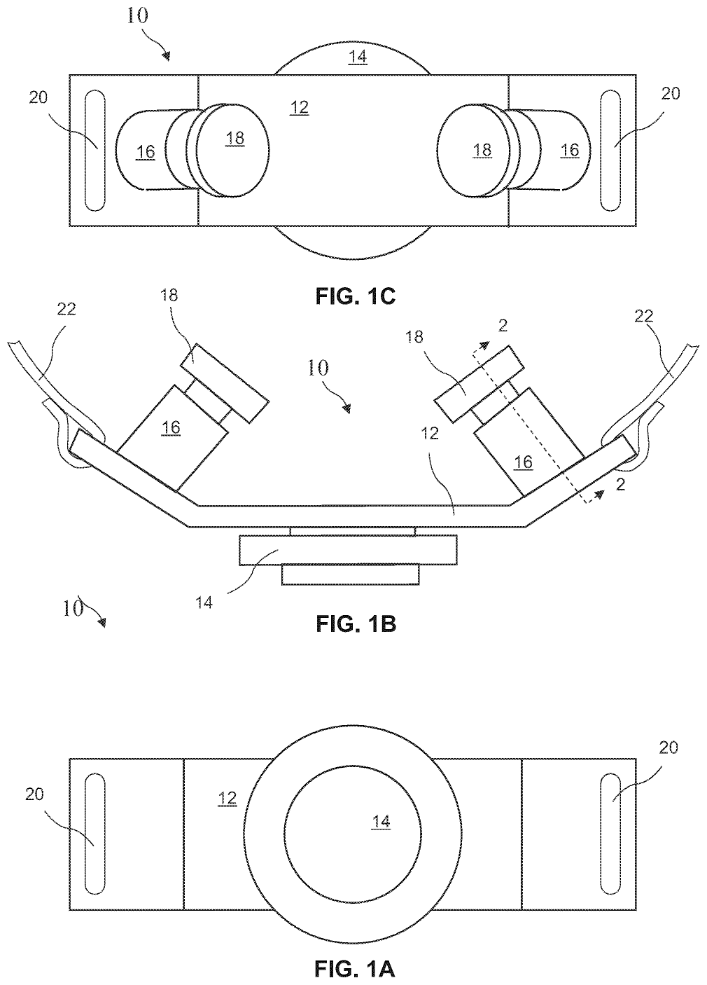

A front view of a laryngeal nerve exciter 10 according to the present invention is shown in FIG. 1a, a top view of the laryngeal nerve exciter 10 is shown in FIG. 1B, and a rear view of the laryngeal nerve exciter 10 is shown in FIG. 1C. The laryngeal nerve exciter 10 includes a bridge 12, an exciter 14, effector sleeves 16, end effectors 18, strap slots 20, and a strap 22. The exciter 14 is preferably a solenoid or a voice coil, or any device capable of generating vibrations at various frequencies, for example, vibrations between 30 and 200 Hz and preferably between 70 and 110 HZ and sufficiently strong to reach the laryngeal nerve for example, a pressure of 2-4 kpa or a vibration amplitude of 0.15 mm to 0.25 mm.

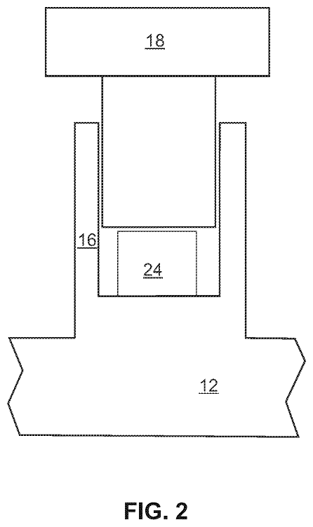

The end effector 18 of the laryngeal nerve exciter 10 is shown in FIG. 2. A force sensor 24 resides under each end effector 18 and provides force information to allow adjusting the tightness of the strap 22.

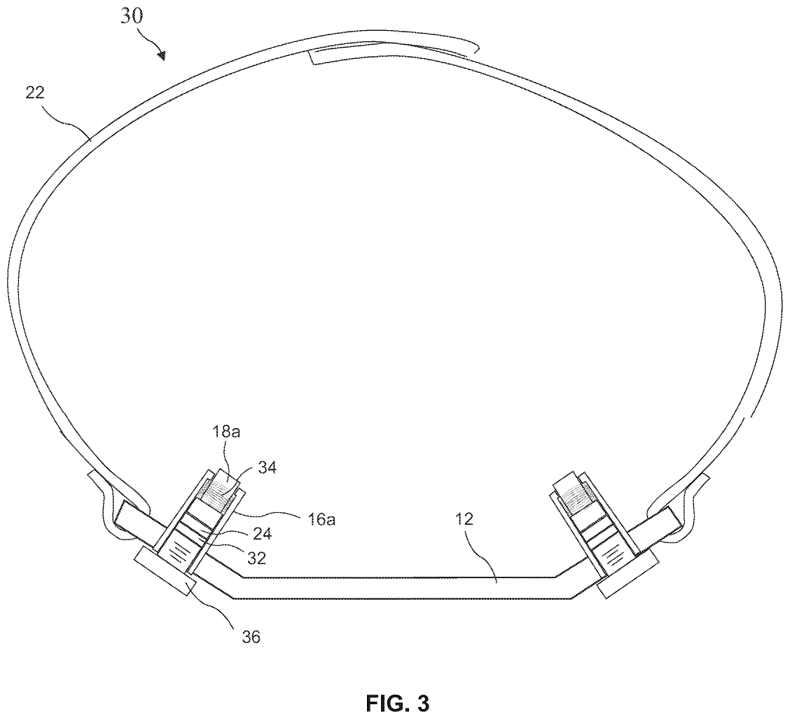

A top view of a second embodiment of a laryngeal nerve exciter 30 is shown in FIG. 3. The laryngeal nerve exciter 30 includes end effectors 18a held inside sleeves 16a and springs (or a resilient material) 34 holding the end effectors 18a against transducers 32. An adjust screw 36 presses the transducer 32 and end effector 18a against the spring 34 allowing adjustment of the end effectors 18a against the patient's neck without adjusting the strap 22. The transducers 32 may both vibrate the end effectors 18a to stimulate the laryngeal nerve and may sense a patient's attempt to swallow, and may sense stimulation by the other end effector 18a. The laryngeal nerve exciter 30 may include the force sensor 24 under the effector 16a. In another embodiment, the end effectors 18a may be fixedly attached to the moving part of the transducers 32 and no spring 34 is required.

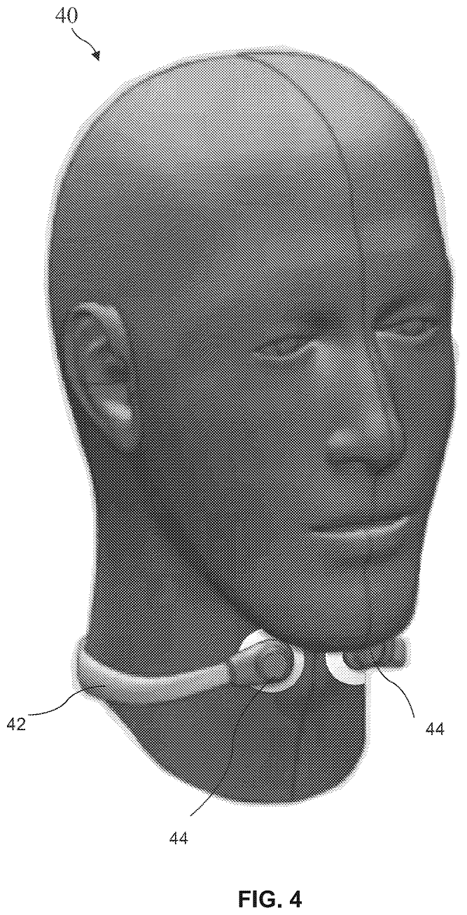

FIG. 4 shows a neckband laryngeal nerve exciter (neckband trainer) 42 on a patient 40. The neckband trainer 42 does not press against the patient's throat providing greater comfort for the patient. Two exciters 44 are pressed against sides of the neck. The exciters 44 preferably receive up to 10 Watts (five Watts per exciter). The neckband trainer 42 provides pressure to the area where the exciters 44 contact the neck. The force of the exciters 44 against the neck is measured and an alarm is generated if the force exceeds a threshold.

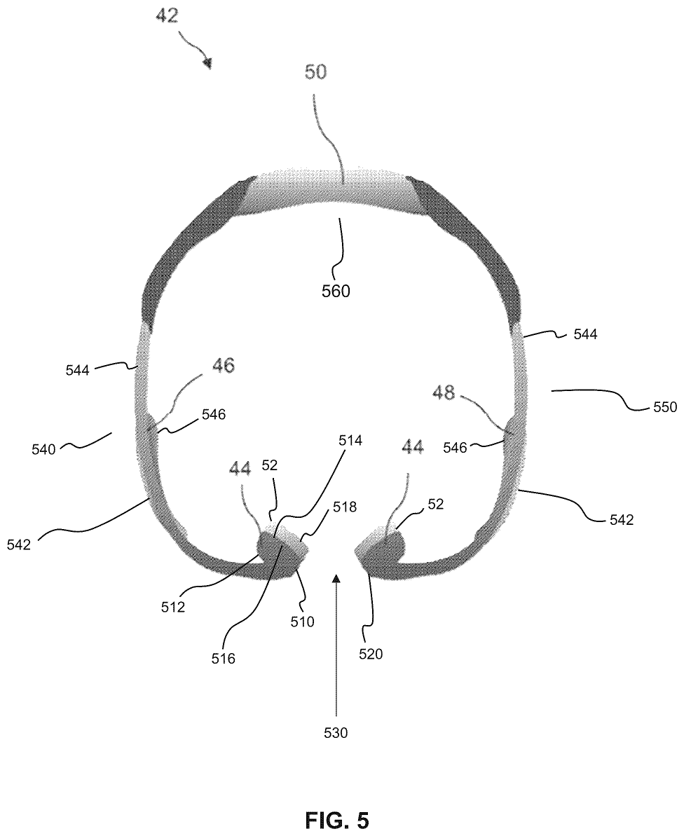

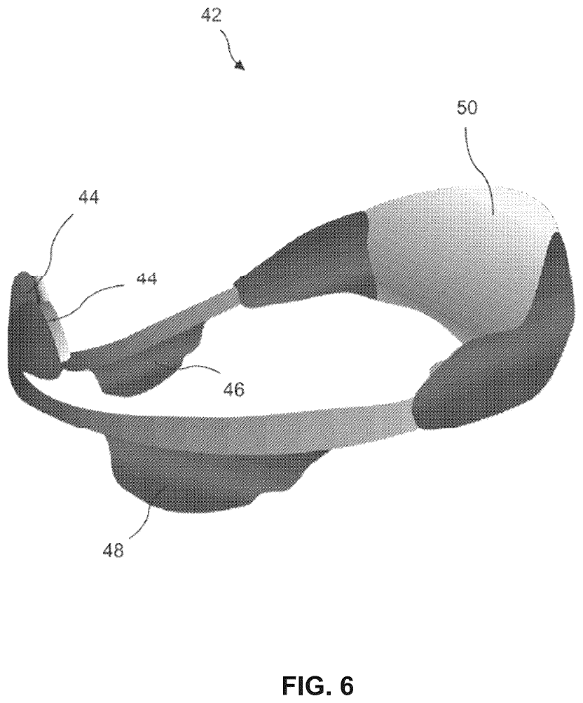

FIG. 5 shows a top view of the neckband trainer 42 and FIG. 6 shows a perspective view of the neckband trainer 42. The neckband trainer 42 includes the exciters 44, circuits 46 and 48, and a battery compartment 50. The neckband trainer 42 includes a charging port for charging batteries and is adjustable for individual patients. The neckband trainer 42 may include a first free end 510, a second free end 520, a first side portion 540, a second side portion 550, and a center portion 560. The first free end 510 and the second free end 520 form an open front 530. Each exciter 44 may include a first surface 512 coupled to the first free end 510 and a second surface 514 opposing the first surface 512. Each of the first side portion 540 and the second side portion 550 may include a first region 542 and a second region 544 closer to the center portion 560 than the first region 542. Each first region 542 may include a housing 546 mounted thereon and accommodate a first electrical circuit 46 or a second electrical circuit 48. Each first region 542 may be larger in size than each second region 544 due to the housing 546. The neckband trainer 42 may also include a first adhesive pad and a second adhesive pad 52. Each adhesive pad 52 may include a first surface 516 respectively coupled to the second surface 514 of each of the first exciter or the second exciter 44, and a second surface 518 opposing the first surface 516 of each of first adhesive pad or the second adhesive pad 52.

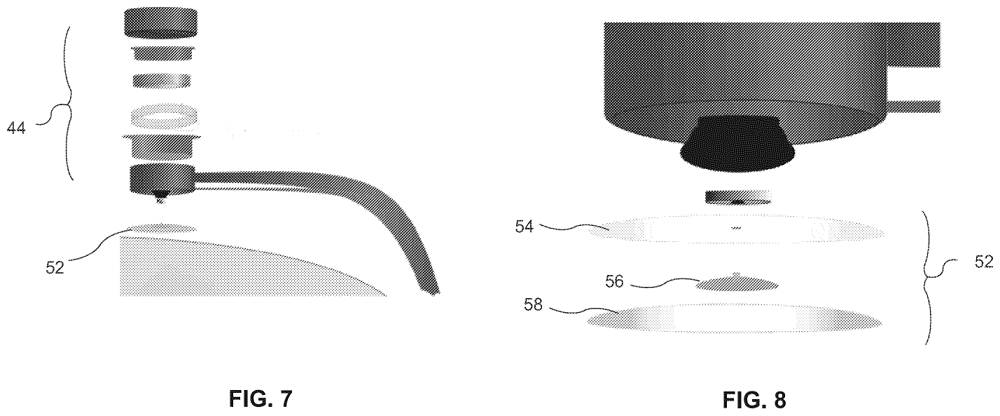

FIG. 7 shows a nerve exciter 44 of the neckband laryngeal nerve exciter.

FIG. 8 shows an adhesive pad 52 of the neckband trainer 42. The adhesive pad 52 comprises a top adhesive pad 54, a plastic snap 56, and a bottom adhesive pad 58. The exciter 44 snaps onto the adhesive pad 52 to retain the exciter 44 against the patient's neck.

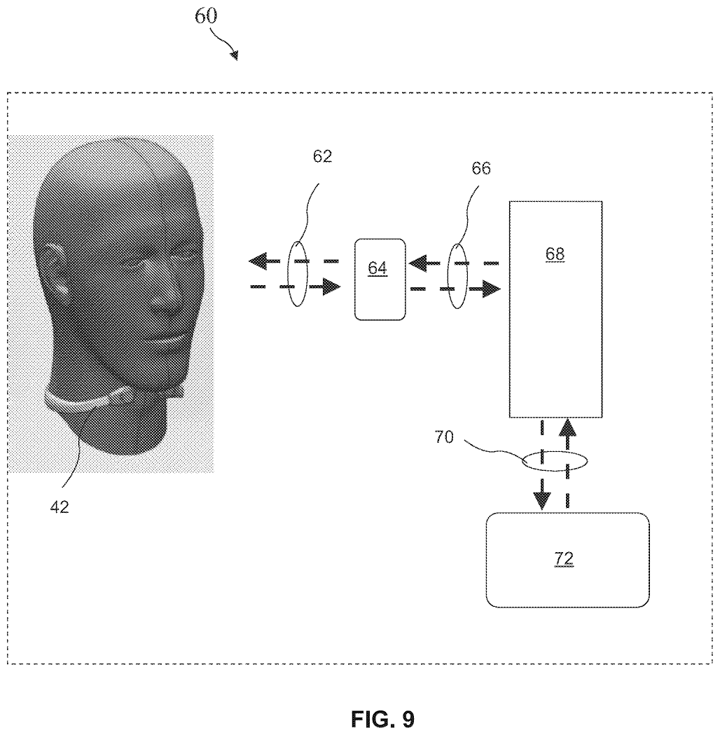

A laryngeal nerve exciter system 60 is shown in FIG. 9. The system 60 utilizes a software Application (App) residing in a Personal Digital Assistant (PDA) 64 which triggers, and monitors the neckband trainer 42 through a Bluetooth® interface 62. The interface 62 may include frequency, intensity, therapy time, vibration time, duration of rest period between vibration, and allows for patients to provide feedback about the therapy.

The PDA 64 may communicate with a secure server 68 through the Internet or any other suitable connection including wireless or wired connections 66 providing signals include frequency, intensity, therapy time, vibration time, duration of rest period between vibration, clinician calibration, and allows for patients to provide feedback about the therapy.

The secure server 68 may communicate with a work station 72 over the Internet or any other suitable connection including wireless or wired connections 70 providing signals include frequency, intensity, therapy time, vibration time, duration of rest period between vibration, and clinician calibration, and allows for patients to provide feedback about the therapy to the clinician.

The App may set the frequency of the neckband trainer 42, intensity, therapy time, vibration time, duration of rest period between vibration, and allows for patients to provide feedback about the therapy. Measurements made by the neckband trainer 42 (e.g., force measured by the exciters) may be provided to the PDA 64 via the Bluetooth® connection. Further, the system 60 may allow clinicians to monitor the patient's progress. The clinician will be able to see the device settings, frequency of the device, intensity, therapy time, vibration time, duration of rest period between vibration, number of uses, whether therapy was completed, and the patient feedback. A general state of health section for the patient may be provided to indicate how the patient is feeling before and after the therapy. The PDA 64 may be a smart phone.

While the invention herein disclosed has been described by means of specific embodiments and applications thereof, numerous modifications and variations could be made thereto by those skilled in the art without departing from the scope of the invention set forth in the claims.

What is claimed is:

1. A method of wirelessly controlling, with a personal digital assistant, a neckband worn on a neck of a person, the method comprising:
establishing a wireless communication link, via a first communication interface, with at least one of a first electrical circuit or a second electrical circuit, respectively disposed in a first side portion and a second side portion of the neckband;
wirelessly controlling a power source, accommodated in a power source compartment disposed between and thicker than a first side portion and a second side portion of the neckband, to power at least one of the first electrical circuit or the second electrical circuit;
causing at least one of a first exciter or a second exciter of the neckband, respectively electrically coupled to the first electrical circuit and the second electrical circuit, to generate at least one of a first vibration or a second vibration; and
causing the neckband to vibrationally excite a laryngeal nerve of the person by conducting at least one of the first vibration or the second vibration to the person's neck.

2. The method of claim 1, further comprising wirelessly controlling the neckband to measure force of at least one of the first exciter or the second exciter of the neckband against at least one of a first portion or a second portion of the person's neck.

3. The method of claim 2, further comprising wirelessly controlling the neckband to generate an alarm in response to the measured force exceeding a threshold.

4. The method of claim 2, further comprising wirelessly controlling the neckband to send the measured force to the personal digital assistant.

5. The method of claim 1, wherein causing at least one of the first exciter or the second exciter comprises wirelessly controlling at least one of the first exciter or the second exciter to generate at least one of the first vibration or the second vibration at a frequency between 30 Hz and 200 Hz, at a pressure of 2 kPa to 4 kPa or at a vibration amplitude of 0.15 mm to 0.25 mm.

6. The method of claim 1, wherein wirelessly controlling the power source comprises providing a power of up to 10 Watts to at least one of the first exciter or the second exciter prior to generating at least one of the first vibration or the second vibration.

7. The method of claim 1, wherein causing the neckband to vibrationally excite the laryngeal nerve comprises vibrationally exciting the laryngeal nerve to treat at least one of a swallow disorder, a voice disorder, or a chronic cough.

8. The method of claim 1, wherein the power source comprises a battery, and wherein wirelessly controlling the power source comprises wirelessly controlling the battery to power at least one of the first electrical circuit or the second electrical circuit.

9. The method of claim 1, wherein the first communication interface comprises a short range communication interface.

10. The method of claim 9, wherein the short range communication interface comprises Bluetooth.

11. The method of claim 10, further comprising wirelessly monitoring an operational status of the neckband via Bluetooth.

12. The method of claim 1, further comprising:
receiving information regarding at least one of a frequency of the first vibration or the second vibration, an intensity of the first vibration or the second vibration, therapy time, vibration time, or duration of rest period between vibration; and
wirelessly sending the received information to at least one of the first electrical circuit or the second electrical circuit of the neckband to control at least one of the first electrical circuit or the second electrical circuit.

13. The method of claim 12, further comprising receiving a person's feedback regarding therapy on the personal digital assistant.

14. The method of claim 13, further comprising utilizing a software application (App) residing in the personal digital assistant to wirelessly control the neckband.

15. The method of claim 14, further comprising setting, using the software application, at least one of pressure on the neck, force, a frequency of the first vibration or the second vibration, an intensity of the first vibration or the second vibration, therapy time, vibration time, or duration of rest period between vibration.

16. The method of claim 14, further comprising enabling the person to provide feedback regarding therapy using the software application.

17. The method of claim 1, further comprising communicating data with a server via a first communication network, wherein the data comprises one or more of pressure on the neck, force, at least one of a frequency of the first vibration or the second vibration, an intensity of the first vibration or the second vibration, therapy time, vibration time, duration of rest period between vibration, clinician calibration, or a person's feedback.

18. The method of claim 17, further comprising causing the server to communicate the data with a healthcare provider's computer via a second communication network.

19. The method of claim 18, further comprising causing the healthcare provider's computer to monitor a treatment progress of the person.

20. The method of claim 19, wherein the treatment progress comprises one or more of: neckband settings, pressure on the neck, force, a frequency of the first vibration or the second vibration, an intensity of the first vibration or the second vibration, therapy time, vibration time, duration of rest period between vibration, number of uses, whether therapy has been completed, a person's feedback, or information indicating how the person is feeling before and after the therapy.

21. The method of claim 1, wherein the personal digital assistant comprises a smartphone.
